(19) United States
(12) Patent Application Publication
(10) Pub. No.: US 2026/0233726 A1
(43) Pub. Date: Aug. 13, 2026

(54) SYSTEMS AND METHODS OF CHARGING A VEHICLE BATTERY

(71) Applicant: Scout Motors Inc., Tysons, VA (US)

(72) Inventor: Daniel Davis, West Bloomfield Township, MI (US)

(21) Appl. No.: 19/051,687

(22) Filed: Feb. 12, 2025

(51) Int. Cl. B60W 20/13; B60K 6/46; B60W 20/12; H02J 7/16

(52) U.S. Cl. CPC B60W 20/13; B60K 6/46; B60W 20/12; H02J 7/16; B60W 2510/244; B60W 2510/246; B60W 2530/10; B60W 2555/20; B60W 2555/40; B60Y 2200/92

(57) ABSTRACT

A method of charging a vehicle battery includes: determining a vehicle trajectory of a vehicle; determining, based on the vehicle trajectory, a difference between a maximum elevation along the vehicle trajectory and a minimum elevation along the vehicle trajectory; determining, based on the difference, an amount of energy required to traverse a route segment including the maximum elevation; determining, based on (i) the amount of energy, (ii) a vehicle parameter, and (iii) a vehicle context, a state of charge (SoC) buffer for a vehicle battery; and operating a generator to charge the vehicle battery based on the SoC buffer.

### BACKGROUND

The present disclosure relates generally to the field of battery management systems, and more specifically to systems and methods of charging a vehicle battery.

### SUMMARY

In some aspects, the techniques described herein relate to a method of charging a vehicle battery, including: determining a vehicle trajectory of a vehicle; determining, based on the vehicle trajectory, a difference between a maximum elevation along the vehicle trajectory and a minimum elevation along the vehicle trajectory; determining, based on the difference, an amount of energy required to traverse a route segment including the maximum elevation; determining, based on (i) the amount of energy, (ii) a vehicle parameter, and (iii) a vehicle context, a state of charge (SoC) buffer for a vehicle battery; and operating a generator to charge the vehicle battery based on the SoC buffer.

In some aspects, the vehicle parameter includes at least one of (i) a vehicle mass, (ii) a vehicle energy buffer, (iii) an energy output of the generator, or (iv) a vehicle payload. In some aspects, the vehicle context includes at least one of (i) a temperature measurement, (ii) a wind speed measurement, (iii) a weather condition, or (iv) a surface type. In some aspects, wherein the method further includes determining the vehicle context corresponding to at least one of (i) a location of the route segment or (ii) a location of one or more route segments between the maximum elevation and a current location of the vehicle. In some aspects, the method further includes: receiving a measurement from a sensor positioned on the vehicle; and determining the vehicle context based on the measurement. In some aspects, operating the generator includes comparing the SoC buffer to a current charge of the vehicle battery. In some aspects, the vehicle trajectory includes a route having a length, and wherein the route includes two branches, wherein each of the two branches corresponds to a different destination.

In some aspects, the techniques described herein relate to a series hybrid vehicle, including: a battery; a generator; and a computing device including: a non-transitory computer-readable storage medium having instructions that, when executed by a processor, cause the processor to: determine a trajectory of the series hybrid vehicle; determine, based on the trajectory, a difference between a maximum elevation along the trajectory and a minimum elevation along the trajectory; determine, based on the difference, an amount of energy required to traverse a route segment including the maximum elevation; determine, based on (i) the amount of energy, (ii) a vehicle parameter, and (iii) a vehicle context, a SoC buffer for the battery; and operate the generator to charge the battery based on the SoC buffer.

In some aspects, the vehicle parameter includes at least one of (i) a vehicle mass, (ii) a vehicle energy buffer, (iii) an energy output of the generator, or (iv) a vehicle payload. In some aspects, the vehicle context includes at least one of (i) a temperature measurement, (ii) a wind speed measurement, (iii) a weather condition, or (iv) a surface type. In some aspects, the instructions further cause the processor to determine the vehicle context corresponding to at least one of (i) a location of the route segment or (ii) a location of one or more route segments between the maximum elevation and a current location of the vehicle. In some aspects, the techniques described herein relate to a series hybrid vehicle, further including a sensor, and wherein the instructions further cause the processor to: receive a measurement from the sensor; and determine the vehicle context based on the measurement. In some aspects, operating the generator includes comparing the SoC buffer to a current charge of the battery. In some aspects, the vehicle trajectory includes a route having a length, and wherein the route includes two branches, wherein each of the two branches corresponds to a different destination.

In some aspects, the techniques described herein relate to a non-transitory computer-readable medium including instructions that, when executed by one or more processors of one or more computing devices, cause the one or more processors to: determine a vehicle trajectory of a vehicle; determine, based on the vehicle trajectory, a difference between a maximum elevation along the vehicle trajectory and a minimum elevation along the vehicle trajectory; determine, based on the difference, an amount of energy required to traverse a route segment including the maximum elevation; determine, based on (i) the amount of energy, (ii) a vehicle parameter, and (iii) a vehicle context, a SoC buffer for a battery of the vehicle; and operate a generator to charge the battery based on the SoC buffer.

In some aspects, the vehicle parameter includes at least one of (i) a vehicle mass, (ii) a vehicle energy buffer, (iii) an energy output of the generator, or (iv) a vehicle payload. In some aspects, the vehicle context includes at least one of (i) a temperature measurement, (ii) a wind speed measurement, (iii) a weather condition, or (iv) a surface type. In some aspects, the instructions further cause the one or more processors to determine the vehicle context corresponding to at least one of (i) a location of the route segment or (ii) a location of one or more route segments between the maximum elevation and a current location of the vehicle. In some aspects, the instructions further cause the one or more processors to: receive a measurement from a sensor positioned on the vehicle; and determine the vehicle context based on the measurement. In some aspects, operating the generator includes comparing the SoC buffer to a current charge of the battery.

### BRIEF DESCRIPTION OF THE DRAWINGS

The above and other aspects and features of the present disclosure will become more apparent to those skilled in the art from the following detailed description of the example embodiments with reference to the accompanying drawings.

FIG. 1 illustrates an example vehicle with an example battery management system, according to an exemplary embodiment.

FIG. 2 illustrates an example of determining an SoC buffer for a vehicle trajectory, according to an exemplary embodiment.

FIG. 3 illustrates another example of determining an SoC buffer for a vehicle trajectory, according to an exemplary embodiment.

FIG. 4 is a flowchart illustrating a method of charging a vehicle battery, according to an exemplary embodiment.

FIG. 5 is an example of managing a battery system while traversing a route, according to an exemplary embodiment.

FIG. 6 is a flowchart illustrating another method of charging a vehicle battery, according to an exemplary embodiment.

FIG. 7 is a schematic of an example vehicle, according to an exemplary embodiment.

### DETAILED DESCRIPTION

Referring generally to the FIGURES, described herein are systems and methods of charging a vehicle battery. In various contexts it may be necessary or beneficial to dynamically manage a state of charge for a vehicle battery. For example, in a series hybrid it may be necessary to dynamically manage a state of charge of the vehicle battery in order to ensure that the vehicle battery has enough energy to meet the energy demands of a driver. In various contexts, managing the state of charge for a vehicle battery includes charging the battery. For example, a series hybrid may charge a vehicle battery using an engine/generator. In various contexts, charging a vehicle battery may extend a continuous range of the vehicle (e.g., how far the vehicle can travel before it needs to stop for fuel/charging, etc.). In some contexts, it may be more efficient to charge a vehicle battery when the vehicle battery is at a low state of charge than it is to charge the vehicle battery when the vehicle battery is at a higher state of charge. For example, it may be more efficient to charge a lithium-ion (Li-ion) battery at a low state of charge (e.g., due to factors such as the internal resistance of the battery, the ion diffusion rate of the battery, the thermal efficiency of the battery, and/or the like). As another example, in order to increase the life of a Li-ion battery and maximize charging efficiency, it may be optimal to charge the Li-ion battery when it is partially discharged (e.g., at around 20-30% state of charge, etc.) and stop charging the battery when it is mostly charged (e.g., at around 80-90% state of charge, etc.). Therefore, it may be necessary or beneficial to wait to charge a vehicle battery until the vehicle battery is at a state of charge that corresponds to efficient charging (e.g., partially discharged, etc.). However, if a vehicle battery is partially discharged it may not be able to provide enough energy to meet the energy demands of a driver. For example, if a driver wishes to drive up a hill that requires 1,200 kJ of energy to traverse but their vehicle battery only has 1,000 kJ of usable energy stored, then the driver may not be able to traverse the entire hill. Therefore, in some contexts, efficiently charging a vehicle battery may be in tension with maintaining a state of charge for the vehicle battery that is sufficient to meet the energy demands of a driver. Accordingly, there is a need for systems and methods of charging a vehicle battery that balance efficiently charging the vehicle battery (e.g., thereby increasing the continuous range of the vehicle) with maintaining a sufficient SoC buffer to ensure that the vehicle battery can meet the energy demands of a driver.

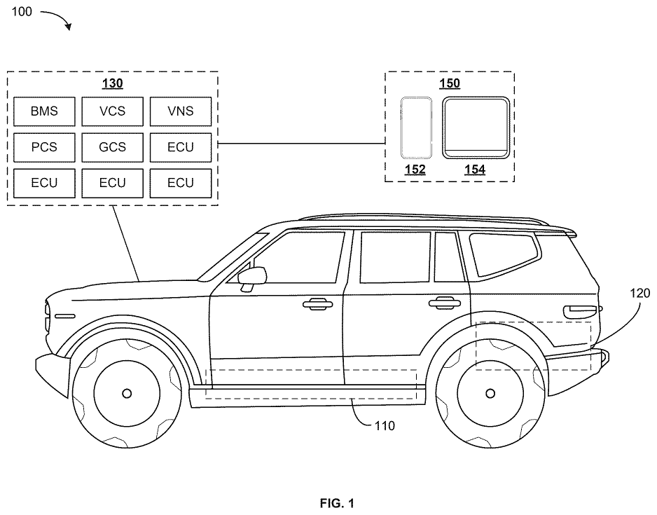

Referring now to FIG. 1, vehicle 100 is shown, according to an exemplary embodiment. In various embodiments, vehicle 100 is an electric vehicle. For example, vehicle 100 may be a pure-electric vehicle, a hybrid electric vehicle (e.g., a series hybrid vehicle, a range extended electric vehicle, an extended-range electric vehicle, etc.), and/or a plug-in electric vehicle. Vehicle 100 may include battery 110, generator 120, and/or control system 130. In some embodiments, vehicle 100 may communicate with computing device(s) 150 (e.g., smartphone 152, vehicle accessory 154, etc.).

As used herein, “electric vehicle” refers to any type of vehicle that includes an electric motor as a primary mover (e.g., source of propulsion). As used herein, “propulsion” refers to the action of driving or moving vehicle 100 where the movement is caused by a prime mover of vehicle 100. As used herein, “series hybrid vehicle” refers to any type of vehicle that uses electrical energy as a sole source of power, wherein the electrical energy is supplied by two or more sources. For example, as used herein, a series hybrid vehicle may differ from a parallel hybrid vehicle in that a parallel hybrid vehicle may include an internal combustion engine that is directly/mechanically linked to a drive train while in a series hybrid vehicle the internal combustion engine is not directly/mechanically linked to the drive train.

Battery 110 may be a lithium-ion battery (e.g., a lithium nickel manganese cobalt battery, a lithium iron phosphate battery, a lithium nickel cobalt aluminum oxide battery, etc.), a sodium-ion battery, a lead-acid battery, and/or the like. In various embodiments, battery 110 provides electrical energy to a prime mover of vehicle 100 to propel vehicle 100. Battery 110 may include one or more battery cells. In some embodiments, battery 110 is removable (e.g., hot-swappable, etc.). In various embodiments, battery 110 has a usable/functional capacity that is different from its total capacity. For example, battery 110 may physically be able to store 0-1,000 kJ of energy but may be operated from 200-800 kJ to prevent damage to battery 110 and/or increase a functional lifetime of battery 110. As used herein, a “state of charge (SoC)” of battery 110 may refer to the percentage of remaining charge in battery 110 relative to a usable/functional range/capacity of battery 110. For example, if a functional range of the capacity of battery 110 is 200-800 kJ and battery 110 currently has 600 kJ of stored energy, then the SoC of battery 110 may be 66.67%. In some embodiments, SoC is used to refer to a current SoC of battery 110 (e.g., a current charge).

Generator 120 may generate/produce electrical energy to charge battery 110. Generator 120 may generate electrical energy from kinetic energy, chemical energy, and/or via the photovoltaic effect. For example, generator 120 may include a hydrogen fuel cell. In various embodiments, generator 120 is and/or includes an electrical generator. For example, generator 120 may include an internal combustion engine that provides kinetic energy to an electromagnetic generator, such as a dynamo and/or an alternator, which in turn produces electrical energy to charge battery 110. In various embodiments, a power output of generator 120 is less than a power output of battery 110. For example, the power output of battery 110 may be 5-8× the power output of generator 120. In such embodiments, energy from battery 110 may be required to meet the energy demands of a driver (e.g., generator 120 may be insufficient to meet the energy demands of a driver, etc.). For example, if a driver wishes to drive up a 5% gradient at 70 miles-per-hour, generator 120 may be unable to provide enough energy to battery 110 to meet these demands without supplemental energy from battery 110 (e.g., previously stored energy, etc.). In various embodiments, generator 120 may configured to supply electrical energy directly to an electric motor of vehicle 100 (e.g., to propel vehicle 100). For example, vehicle 100 may be operated solely using electrical energy from generator 120 assuming that the power demands of vehicle 100 do not exceed the power output of generator 120. To continue the example, the power demands of vehicle 100 may exceed the power output of generator 120 when vehicle 100 is traversing elevation; therefore, battery 110 may be required to meet the power demands of vehicle 100 in such examples.

As used herein, “energy” may refer to the capacity to do work or produce change (e.g., as measured in joules, kilowatt-hours, etc.). As used herein, “power” may refer to the rate at which energy is transferred or work is done (e.g., as measured in watts, etc.).

Control system 130 may directly and/or indirectly control systems/components of vehicle 100. As shown in FIG. 1, control system 130 may include one or more electronic control units (ECUs), each of which are dedicated to a specific set of functions. Each ECU may be a computer system and each ECU may include functionality provided by one or more of the example ECUs described below. A battery management system (BMS) ECU may monitor and/or control battery 110. For example, the BMS ECU may monitor an SoC of battery 110, predict future energy needs of vehicle 100, and cause battery 110 to be selectively charged based on the predicted future energy needs. In various embodiments, the BMS ECU causes battery 110 to be charged (e.g., by generator 120, etc.) in a manner that extends a continuous operational range of vehicle 100 (e.g., by charging battery 110 in efficient conditions such as when battery 110 is partially discharged, etc.). the BMS ECU may control the flow of energy into and out of battery 110. For example, the BMS ECU may simultaneously charge battery 110 via generator 120 and an external power supply (e.g., electric vehicle supply equipment such as fast charging station, etc.). In various embodiments, the BMS ECU receives inputs from various sensors and/or control systems of vehicle 100.

A vehicle context system (VCS) ECU may determine one or more parameters that describe a context of vehicle 100. For example, the VCS ECU may determine weather conditions, road conditions, vehicle wear, and/or the like. In various embodiments, the VCS ECU determines the one or more parameters based on sensor measurements (e.g., from sensors positioned on vehicle 100, etc.). For example, the VCS ECU may receive temperature measurements (e.g., of ambient air, etc.), wind speed measurements, altitude measurements, humidity measurements, precipitation measurements, road surface measurements, vehicle body roll measurements, vehicle payload measurements, global positioning system (GPS) measurements, and/or the like from one or more sensors disposed on vehicle 100. Additionally or alternatively, the VCS ECU may determine the one or more parameters based on receiving information from one or more external systems. For example, the VCS ECU may query a weather database to receive weather information (e.g., a forecast, wind speeds, temperature, etc.) corresponding to a location. The one or more parameters may include, but are not limited to, (i) a temperature measurement (e.g., of a region/component of vehicle 100 such as a battery temperature, etc.), (ii) a wind speed measurement, (iii) a weather condition (e.g., rain, snow, hail, thunderstorm, flood, tornado, hurricane, etc.), and/or (iv) a surface type (e.g., concrete, asphalt, gravel, paved, unpaved, etc.). In various embodiments, the surface type includes a road surface friction coefficient. In various embodiments, the one or more parameters include vehicle parameters. For example, the one or more parameters may include a vehicle mass, a vehicle energy parameter, a battery temperature, an energy output of the generator, and/or a vehicle payload.

A vehicle navigation system (VNS) ECU may determine a vehicle trajectory. For example, the VNS ECU may determine a path from a current location/orientation of vehicle 100 to a location a distance (e.g., a predetermined distance, etc.) from the current location. In some embodiments, the VNS ECU determines the vehicle trajectory by tracing a path of the road the vehicle is currently on until a threshold distance is achieved. For example, if the vehicle is currently traveling on a highway, the VNS ECU will assume the vehicle will stay on the highway (as long as the highway continues) and will generate the vehicle trajectory as a path between the current location of the vehicle and a point 100 miles from the current location of the vehicle (along the highway) in a direction of travel of the vehicle. In various embodiments, if the road the vehicle is traveling on branches (e.g., terminates in an intersection such as a three-way junction, etc.), then the VNS ECU may generate branches for the vehicle trajectory. For example, the VNS ECU may trace each branch in the road until a total path length is achieved (e.g., such that the resulting vehicle trajectory includes a number of branches, each corresponding a branch in the road, etc.). As used herein, a “vehicle trajectory” refers to a path between a current location of the vehicle and one or more other locations where the path is constrained to improved surfaces for use by vehicles (e.g., navigable/traversable roads, streets, highways, etc.).

A power control system (PCS) ECU may control power supply to one or more prime movers. For example, the PCS ECU may route power from battery 110 to one or more electric motors. In various embodiments, the PCS ECU measures one or more electrical parameters associated with the one or more prime movers. For example, the PCS ECU may measure input voltage, input current, and/or input impedance of one or more electric motors. In some embodiments, the PCS ECU may determine one or more characteristics associated with operation of vehicle 100 based at least in part on the one or more electrical parameters. For example, the PCS ECU may determine, based on a velocity and/or acceleration of vehicle 100 and an input current to the one or more prime movers, whether vehicle 100 is towing a payload. As another example, the PCS ECU may determine, based on the input current to the one or more prime movers, weather data, and a rolling resistance associated with vehicle 100, a drag coefficient for vehicle 100 associated with wind acting on vehicle 100.

A generator control system (GCS) ECU may monitor and/or control generator 120. In various embodiments, the GCS ECU operates generator 120 in response to input from the BMS ECU. For example, the BMS ECU may determine that battery 110 needs to be charged to achieve a desired SoC buffer and may cause, via the GCS ECU, generator 120 to generate electrical energy to charge battery 110. In various embodiments, the GCS ECU operates an internal combustion engine of generator 120. For example, the GCS ECU may start, stop, and/or throttle an internal combustion engine of generator 120 based on an amount of energy needed for vehicle 100. In some embodiments, the GCS ECU operates a fuel cell of generator 120.

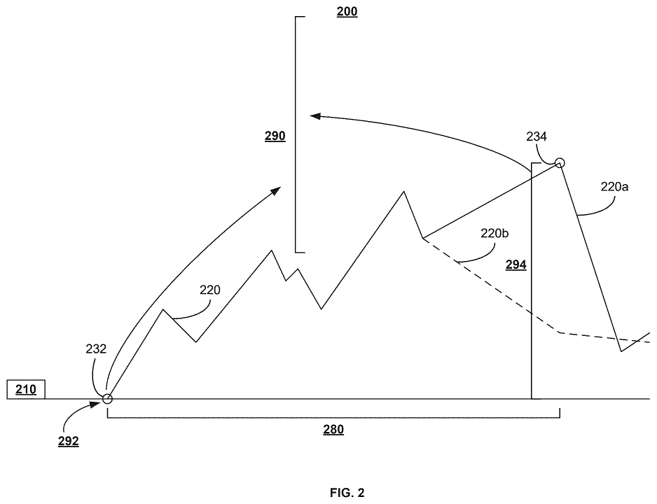

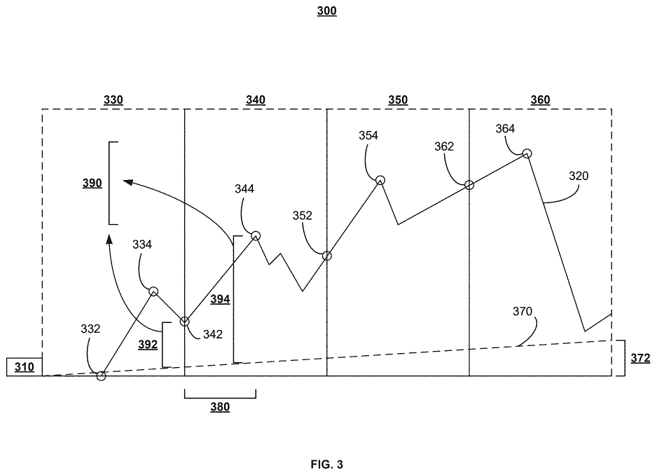

Referring now to FIGS. 2-3, two examples of determining an SoC buffer for a vehicle are shown, according to various embodiments. Speaking generally, systems and methods of the present disclosure may extend a continuous operating range of an electric vehicle by efficiently charging a battery of the electric vehicle while maintaining a sufficient energy buffer to ensure that the energy demands of a driver of the electric vehicle are satisfied. Systems and methods of the present disclosure may offer benefits over conventional systems by (i) reducing computational complexity by calculating energy buffers in terms of energy rather than power (although it should be understood that energy buffers may also be calculated in terms of power), (ii) increasing robustness by dynamically determining a vehicle trajectory rather than requiring a predefined route (although it should be understood that a predefined route can also be used), and/or (iii) reducing memory requirements by determining energy requirements based on elevation rather than requiring a database of geofence data (although it should be understood that geofenced data can also be used).

Referring now specifically to FIG. 2, example 200 of determining an SoC buffer for a vehicle trajectory is shown, according to an exemplary embodiment. In example 200, vehicle 210 traverses a route (shown as vehicle trajectory 220). In various embodiments, vehicle trajectory 220 represents one or more possible paths that vehicle 210 may take. For example, vehicle trajectory 220 may include a first path that involves vehicle 210 traveling on the same road it is currently on for another 200 miles and a second path that involves vehicle 210 traveling on the same road it is currently on for 100 miles and then turning onto a different road and continuing on that road for 100 miles. In various embodiments, vehicle trajectory 220 is determined with respect to a predetermined travel distance (e.g., 100 miles from a current location along roads, etc.). In various embodiments, the VNS ECU generates vehicle trajectory 220.

Vehicle trajectory 220 may include one or more endpoints/destinations. For example, if a road that vehicle 210 is currently traveling on branches into two options (shown as vehicle trajectory 220a and vehicle trajectory 220b), then vehicle trajectory 220 may include two destinations (e.g., one for each branch). As shown in FIG. 2, vehicle trajectory 220 may represent an elevation profile for one or more possible paths of vehicle 210 (here, two are shown). The horizontal line that vehicle 210 sits on may represent a current elevation of vehicle 210. As shown in FIG. 2, vehicle trajectory 220 continues at the same elevation (e.g., along the horizontal line) until it reaches a number of mountains (illustrated by changes in the elevation profile). In various embodiments, an elevation profile may be generated for each possible path (e.g., each branch) of vehicle trajectory 220. For example, FIG. 2 illustrates a first elevation profile corresponding to vehicle trajectory 220a and a second elevation profile corresponding to vehicle trajectory 220b. For each branch in vehicle trajectory 220 (i.e., for each elevation profile), the vehicle (e.g., the BMS ECU, etc.) may generate an SoC buffer as discussed below.

Systems and methods of the present disclosure may decompose vehicle trajectory 220 into one or more components. For example, the BMS ECU may decompose vehicle trajectory 220 into a horizontal component (shown as horizontal distance 280) and a vertical component (shown as vertical distance 290). In various embodiments, the BMS ECU determines the highest elevation along vehicle trajectory 220 (shown as maximum elevation 234). Additionally, the BMS ECU may determine the lowest elevation between vehicle 210 and maximum elevation 234 (shown as minimum elevation 232). Minimum elevation 232 may be associated with an elevation value (shown as elevation 292). Likewise, maximum elevation 234 may be associated with an elevation value (shown as elevation 294). In various embodiments, horizontal distance 280 is measured between minimum elevation 232 and maximum elevation 234. Elevation 292 and/or elevation 294 may be determined with respect a current elevation of vehicle 210. It should be understood however, that elevation 292 and/or elevation 294 may be determined with respect to a different reference elevation. For example, elevation 292 and/or elevation 294 may be determined with respect to an offset elevation as discussed below with reference to FIG. 3.

The BMS ECU may determine vertical distance 290 as the difference between elevation 294 and elevation 292. While not shown, it should be understood that vehicle trajectory 220b may have its own vertical distance that is different than vertical distance 290. In various embodiments, vehicle trajectory 220a and vehicle trajectory 220b have the same horizontal distance. In some embodiments, a horizontal distance of vehicle trajectory 220a and vehicle trajectory 220b differ. The BMS ECU may determine an energy value associated with horizontal distance 280 and/or vertical distance 290. For example, the BMS ECU may calculate an energy value associated with vertical distance 290 as:

$${E}_{vertial} = m * g * {d}_{v}$$

where m is a mass of vehicle 210, g is acceleration due to gravity, and dᵥ is vertical distance 290. In various embodiments, an amount of energy associated with a combination of horizontal distance 280 and vertical distance 290 is equivalent to an amount of energy associated with vehicle trajectory 220.

Additionally or alternatively, the BMS ECU may determine an amount of energy needed to traverse vertical distance 290. For example, the BMS ECU may calculate the amount of energy needed to traverse vertical distance 290 as:

$${E}_{traverse}^{vertical} = \frac{{E}_{vertical} + {E}_{losses}}{η}$$

where η is an efficiency factor (e.g., that represents inefficiencies such as how efficient the drivetrain is at converting energy from battery 110 into work to propel vehicle 100, etc.) and Eₗₒₛₛₑₛ represents energy required to overcome losses such as aerodynamic drag, rolling resistance, and/or the like. In some embodiments,

$${E}_{traverse}^{vertical}$$

is determined by multiplying a constant (e.g., a value that encodes various parameters such as losses, mass, and/or the gravitational constant) by vertical distance 290.

The amount of energy needed to traverse a distance may differ from the amount of energy associated with a distance in that the amount of energy needed to traverse a distance accounts for losses (e.g., due to drag, rolling resistance, drivetrain losses, etc.). The amount of energy needed to traverse a distance may be calculated in various units. For example, the among of energy needed to traverse a distance may be calculated in kilowatt-hours (kWh), kilojoules (kJ), and/or the like. In various embodiments, calculating the energy needed to traverse a distance in terms of energy reduces computational complexity compared with other methods such as calculating the energy needed to traverse a distance in terms of power. For example, the energy needed to traverse a 1 km elevation change over a 10% grade and a 5% grade may be similar. The BMS ECU may determine an amount of energy required to traverse vehicle trajectory 220. For example, the BMS ECU may determine an amount of energy required to traverse vehicle trajectory 220a and vehicle trajectory 220b and select the greater of the two. The BMS ECU may determine the amount of energy required to traverse vehicle trajectory 220 as:

$${E}_{traverse} = \frac{{E}_{vertical} + {E}_{h o rizontal} + {E}_{losses}}{η}$$

where E_{horizontal} is the energy value associated with horizontal distance 280. In some embodiments, Eₗₒₛₛₑₛ and η are combined into a loss factor. For example, Eₜᵣₐᵥₑᵣₛₑ may be multiplied by a loss factor of 110%. The BMS ECU may determine an SoC buffer based on the amount of energy required to traverse vehicle trajectory 220. Alternatively, the BMS ECU may determine the SoC buffer based on the amount of energy required to traverse horizontal distance 280 or vertical distance 290. In some embodiments, the BMS ECU determines the SoC buffer by subtracting a charging capacity of generator 120 from the amount of energy required to traverse vehicle trajectory 220. In various embodiments, the SoC buffer corresponds to an amount of usable/functional energy that battery 110 may need in order to traverse vehicle trajectory 220 or a component thereof (e.g., vertical distance 290, etc.). For example, if the BMS ECU determines the required SoC buffer is 800 kJ and a functional range of the capacity of battery 110 is 200-3,000 kJ, then the BMS ECU may charge battery 110 to at least 1,000 kJ (e.g., corresponding to an SoC of 800 kJ). In various embodiments, the power and/or energy output of a battery of vehicle 100 may change based on a SoC of the battery (e.g., due to a decrease in battery voltage as the SoC decreases). For example, for a battery with 1000 kWh of usable energy, the difference between 99% SoC and 98% SoC may represent 1.25 kWh of energy while the difference between 5% SoC and 6% SoC may represent 0.75 kWh of energy.

In various embodiments, the BMS ECU operates generator 120 to achieve the required SoC buffer by the time vehicle 210 reaches minimum elevation 232. For example, if generator 120 is capable of generating a maximum of 10 kJ/mile and battery 110 requires 1,000 kJ of additional energy to satisfy the SoC buffer, then the BMS ECU may operate generator 120 to start charging battery 110 at least 200 miles before vehicle 210 reaches minimum elevation 232. In various embodiments, the BMS ECU generates a distance-until arrival to facilitate determining when to charge battery 110. For example, the BMS ECU may compare a current position of vehicle 100 to a location of minimum elevation 232 to determine the distance-until arrival. In various embodiments, the BMS ECU determines the distance-until arrival at which generator 120 needs to begin charging battery 110 based on the formula:

$$Energy per meter = mass * gravitational constant * distance * losses$$

where mass is a mass of vehicle 100, gravitational constant is 9.81 m/s², distance is 1 meter, and losses is a calibratable parameter based on vehicle losses (e.g., 110%). In some embodiments, energy per meter may be calculated as a constant and may be used to determine an amount of energy needed per meter of elevation gain. In various embodiments, the BMS ECU may determine the required charging distance based on an amount of energy needed to traverse an elevation as determined using an energy per meter constant. For example, the BMS ECU may assume a travel speed of 85 miles-per-hour (or 42.353 second per mile) which may require ~40 kW of power to maintain. To continue the example, generator 120 may be capable of producing 65 kW of power, resulting in 25 kW of surplus power for charging battery 110. To continue the example, vehicle 100 may be approaching a 1000 meter elevation climb in 3000 feet and the BMS ECU may determine that it needs to start charging battery 110 35.7 miles before the elevation gain in order to achieve the required SoC buffer (e.g., because 0.0105 kWh/m*1000 m=10.5 kWh of extra energy is needed and generator 120 can produce 25 kW*42.353 s/mile=0.294 kWh of surplus energy per mile). In some embodiments, the BMS ECU may operate generator 120 at a lower power output (e.g., a non-maximum power output) and begin charging battery 110 at a greater distance-until arrival (e.g., to increase fuel efficiency or increase driver comfort, etc.).

Additionally or alternatively, the BMS ECU may operate generator 120 to start charging battery 110 based on a time-until arrival. For example, the BMS ECU may operate generator 120 to start charging battery 110 at least 100 minutes before vehicle 210 reaches minimum elevation 232. In various embodiments, the BMS ECU generates a predicted time-until arrival to facilitate determining when to charge battery 110. For example, the BMS ECU may determine a time-until arrival based on a speed of vehicle 210 and a travel distance to reach minimum elevation 232. As another example, the BMS ECU may determine the time-until arrival based on an adjusted speed limit associated with vehicle trajectory 220. For example, vehicle trajectory 220 may include a first segment that is 10 miles long and has a speed limit of 50 miles/hour (MPH) and a second segment that is 20 miles long and has a speed limit of 75 MPH and the BMS ECU may calculate the time-until arrival as:

$$Time Until Arrival = {\sum }_{i = 1}^{i = ♯ of segments} \frac{segment {length}_{i}}{( segment {speed}_{i} + O )} = \frac{10}{50 + O} + \frac{20}{75 + O}$$

where O is a constant such as 10 MPH.

Referring now to FIG. 3, example 300 of determining an SoC buffer for a vehicle trajectory is shown, according to an exemplary embodiment. Example 300 is similar to example 200 and may illustrate segmenting a vehicle trajectory. For example, the BMS ECU may segment vehicle trajectory 320 of vehicle 310 into a number of segments (shown as first segment 330, second segment 340, third segment 350, and fourth segment 360). For each segment, the BMS ECU may perform a method similar to that described in relation to FIG. 2. In some embodiments, vehicle trajectory 320 is segmented statically (e.g., irrespective of vehicle/environmental/contextual conditions). For example, vehicle trajectory 320 may be segmented into fixed-length segments such as a first segment (closest to vehicle 310) that spans 0-5 miles from vehicle 310 and a second segment (next-closest to vehicle 310) that spans from 5-15 miles from vehicle 310. Additionally or alternatively, vehicle trajectory 320 may be segmented dynamically (e.g., based on vehicle/environmental/contextual conditions). For example, vehicle trajectory 320 may be continuously segmented such that segments increase in distance the farther they are from vehicle 310 and segments may decrease in size based on an amount of elevation variance. In various embodiments, smaller segments are used closer to vehicle 310. As a non-limiting example, segments may span the ranges: 0-5 miles, 5-10 miles, 10-15 miles, 15-25 miles, 25-50 miles, 50-75 miles, 75-100 miles, 100-125 miles, and 125-150 miles ahead of vehicle 310.

As shown in example 300, the BMS ECU may identify a minimum elevation and a maximum elevation for each segment. For example, the BMS ECU may identify minimum elevation 332 and maximum elevation 334 corresponding to first segment 330, minimum elevation 342 and maximum elevation 344 corresponding to second segment 340, minimum elevation 352 and maximum elevation 354 corresponding to third segment 350, and/or minimum elevation 362 and maximum elevation 364 corresponding to fourth segment 360. In some embodiments, the minimum elevation associated with a segment is not in that segment. For example, the BMS ECU may identify minimum elevation 332 and maximum elevation 364 corresponding to fourth segment 360 (e.g., where the identified minimum elevation is the minimum elevation between vehicle 310 and the maximum elevation in a particular segment, regardless of which segment the identified minimum elevation resides within). In various embodiments, the BMS ECU determines horizontal distance 380 as a horizontal distance between the maximum elevation and the minimum elevation associated with the segment. For example, for second segment 340, horizontal distance 380 may be a horizontal distance between maximum elevation 344 and minimum elevation 342. The BMS ECU may determine an elevation for one or more of the identified maximum and/or minimum elevations. For example, the BMS ECU may determine elevation 392 corresponding to minimum elevation 342 and may determine elevation 394 corresponding to maximum elevation 344. In various embodiments, the elevations (e.g., elevation 392, elevation 394, etc.) are determined with respect to an offset (shown as reference 372). Reference 372 may represent a contribution of generator 120 to the energy required to propel vehicle 310 up a vertical component of vehicle trajectory 320. Reference 372 may take different values (e.g., have a different slope and/or intercept) based on characteristics of generator 120. Alternatively, the elevations may be determined with respect to a current elevation of vehicle 310 (as discussed in FIG. 2). The BMS ECU may determine vertical distance 390 as a difference between elevation 394 and elevation 392. In various embodiments, the BMS ECU determines a vertical distance and a horizontal distance corresponding to each segment (e.g., representing the energy required to traverse the maximum elevation in each segment, etc.). Using the corresponding vertical distance and horizontal distance, the BMS ECU may calculate the amount of energy needed to traverse each segment (or a component thereof) as discussed in example 200. For example, for second segment 340, the BMS ECU may determine an amount of energy needed to traverse vertical distance 390. Likewise, the BMS ECU may determine an SoC buffer for each segment. For example, the BMS ECU may determine an SoC buffer corresponding to second segment 340 based on the amount of energy required to traverse vehicle trajectory 320 from minimum elevation 342 to maximum elevation 344. As another example according to a different embodiment, the BMS ECU may determine an SoC buffer corresponding to second segment 340 based on the amount of energy required to traverse vehicle trajectory 320 from minimum elevation 332 to maximum elevation 344. As discussed above, the BMS ECU may operate generator 120 to achieve the required SoC buffer by the time vehicle 310 reaches the minimum elevation corresponding to each segment.

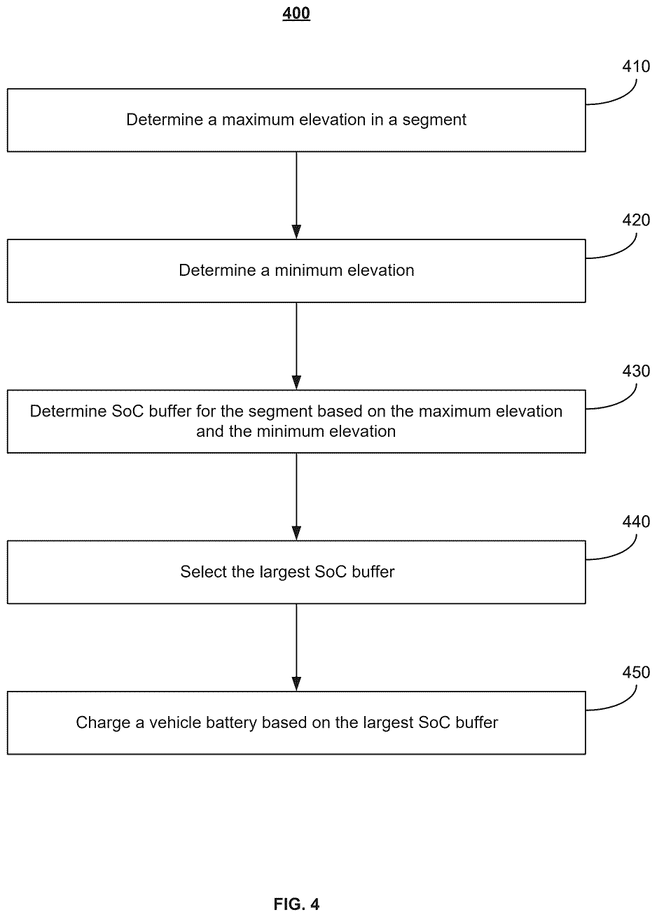

Referring to FIG. 4, method 400 of charging a vehicle battery is shown, according to an exemplary embodiment. In various embodiments, one or more ECUs of vehicle 100 implements method 400. In various embodiments, method 400 facilitates managing an SoC of battery 110 such that battery 110 does not reach 0% SoC while operating (e.g., when charged by generator 120, etc.). For example, method 400 may facilitate managing an SoC of battery 110 so that battery 110 has sufficient energy to propel vehicle 100 up inclines that may require more power to traverse than generator 120 can produce. At step 410, method 400 includes determining a maximum elevation in a segment. For example, the VNS ECU may determine a vehicle trajectory, segment the vehicle trajectory, and determine a maximum elevation along the vehicle trajectory in each segment based on stored elevation data and/or elevation data received from an external source (e.g., in response to querying a map database using the vehicle trajectory).

At step 420, method 400 may include determining a minimum elevation. In some embodiments, step 420 includes determining a number of minimum elevations. For example, the VNS ECU may determine a minimum elevation corresponding to each segment (e.g., where the minimum elevation corresponding to each segment is located within the corresponding segment). As another example, the VNS ECU may determine a minimum elevation corresponding to each segment by identifying the minimum elevation between a current location of the vehicle and the maximum elevation corresponding to that segment, regardless of whether the minimum elevation is located within the same segment as the maximum elevation. In some embodiments, step 420 includes determining a single minimum elevation. For example, the VNS ECU may determine a minimum elevation between a current location of the vehicle and the maximum elevation corresponding to the farthest segment and use that minimum elevation for every segment.

At step 430, method 400 may include determining an SoC buffer for each segment based on the maximum elevation and the minimum elevation. In various embodiments, the BMS ECU determines the SoC buffer for a segment as described in relation to examples 200 and/or 300. For example, the BMS ECU may calculate an SoC buffer for each segment by multiplying a vertical distance (e.g., defined by the difference between a maximum elevation corresponding to the segment and the minimum elevation corresponding, but not necessarily within, the segment, etc.) by a constant that encodes one or more variables (e.g., a mass of the vehicle, the gravitational constant, losses, etc.). In some embodiments, the SoC buffer for each segment corresponds to an amount of energy needed to traverse at least a portion of the segment (e.g., from the first uphill grade within the segment to the maximum elevation within the segment, etc.). In some embodiments, the SoC buffer corresponds to an amount of energy needed to traverse a component of a segment (e.g., a vertical component such as a vertical distance corresponding to a difference between the maximum elevation in the segment and a minimum elevation).

In some embodiments, step 430 includes adjusting the SoC buffer associated with each segment based on various conditions. For example, the BMS ECU may increase the SoC buffer associated with a segment if it determines that the vehicle is towing a heavy payload (e.g., based on information from the VCS ECU, based on a user input, etc.). As another example, the BMS ECU may increase the SoC buffer if a user selects a particular operating mode (e.g., an “off-road” mode, etc.). The conditions may include, but are not limited to, weather conditions (e.g., an ambient temperature, wind speed, presence of rain, presence of snow, etc.), a vehicle operating mode (e.g., “off-road,” “towing,” “mountain,” etc.), and/or a vehicle payload. For example, if an ambient temperature is in a range from 0° C. to −20° C. then the BMS ECU may increase the SoC buffer by 10% and if the ambient temperature is less than −20° C. then the BMS ECU may increase the SoC buffer by 20%.

At step 440, method 400 may include selecting the largest SoC buffer. For example, the BMS ECU may compare the SoC buffer associated with each segment and may identify the largest of the SoC buffers. At step 450, method 400 may include charging a vehicle battery based on the largest SoC buffer. For example, the BMS ECU may cause the GCS ECU to operate generator 120 to charge battery 110 until battery 110 has achieved an SoC corresponding to the largest SoC buffer. In various embodiments, step 450 includes determining a time-until arrival (e.g., as discussed in relation to example 200, etc.). For example, the BMS ECU may calculate the time-until arrival based on a distance until the vehicle reaches a particular point along the vehicle trajectory (e.g., corresponding to the point at which the SoC buffer should be achieved, etc.) and a speed limit associated with the route between a current location of the vehicle and the particular point. In various embodiments, step 450 includes charging the vehicle battery such that the vehicle battery has an instantaneous SoC that is greater than or equal to the largest SoC buffer by the time the vehicle reaches the beginning of a grade.

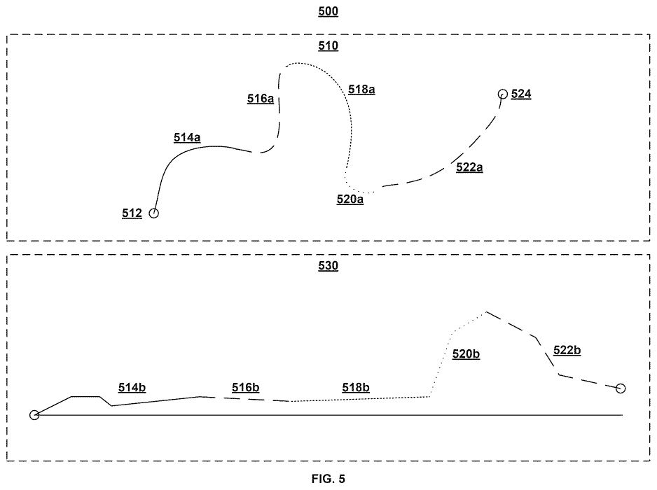

Referring to FIG. 5, example 500 of managing a battery system while traversing a route is shown, according to an exemplary embodiment. Example 500 includes an example vehicle trajectory (shown as trajectory 510) and a corresponding elevation profile (shown as elevation profile 530). Example 500 may illustrate different operating modes of a vehicle as it traverses trajectory 510.

Trajectory 510 is shown to include origin 512 and destination 524. Origin 512 is associated with a minimum elevation along trajectory 510 and destination 524 is associated with a maximum elevation along trajectory 510. Trajectory 510 includes a number of sections corresponding to different operating modes (shown as first section 514, second section 516, third section 518, fourth section 520, and fifth section 522). For each section, a path (indicated by reference numerals with an “a”) and an elevation profile (indicated by reference numerals with a “b”) are shown. In example 500, a vehicle may begin at origin 512 with 100% SoC. The vehicle may traverse first section 514 completely using battery power. At the end of first section 514, the vehicle may be at 0% SoC and a range extender (e.g., generator 120) may begin charging the battery in equilibrium with the energy demands of a driver (e.g., such that the battery remains substantially within 0% SoC while maintaining enough power output to continue to propel the vehicle, etc.). The vehicle may traverse second section 516 completely using power from the range extender. However, in this example, the range extender may be unable to provide enough power to propel the vehicle up fourth section 520. Therefore, an ECU of the vehicle determine an SoC buffer that will fill the gap between the amount of power required to traverse fourth section 520 and an amount of power that the range extender can provide (e.g., the SoC buffer may correspond to 55% SoC). For example, the ECU may determine an amount of energy required to traverse a vertical distance associated with fourth section 520 and generate the SoC buffer based on the determined amount of energy. In this example, it may take the range extender a period of time to charge the battery sufficiently to meet the SoC buffer. Therefore, the vehicle may begin charging the battery in advance of reaching fourth section 520. In this example, the vehicle may traverse third section 518 completely using power from the range extender while using the extra power output of the range extender to charge the vehicle battery such that when the vehicle reaches the incline associated with fourth section 520 an SoC of the vehicle battery is at least equal to the determined SoC buffer. For example, if the SoC buffer corresponds to 55% SoC, then an SoC of the vehicle battery at the end of third section 518 may be 55%. Then the vehicle may traverse fourth section 520 using a combination of battery power and power from the range extender. At the end of the incline associated with fourth section 520, the vehicle may be at 0% SoC. Similar to second section 516, the vehicle may traverse fifth section 522 completely using power from the range extender (e.g., such that the vehicle battery is charged in equilibrium with the energy demands of the driver). For example, at the end of fifth section 522, the vehicle battery may be substantially within 0% SoC).

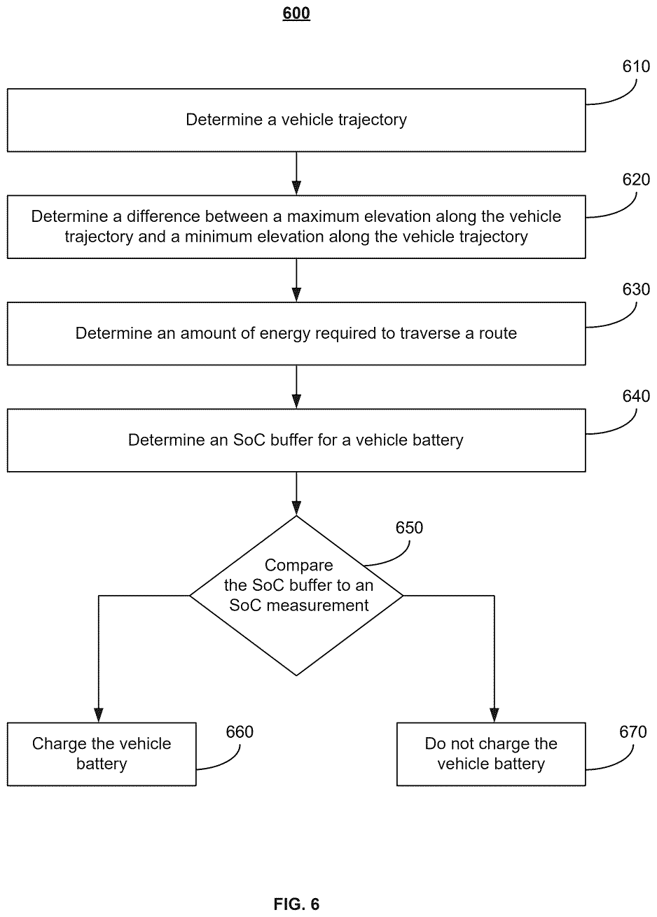

Referring to FIG. 6, method 600 of charging a vehicle battery is shown, according to an exemplary embodiment. In various embodiments, one or more ECUs of vehicle 100 implement method 600. In various embodiments, method 600 is performed in real time during operation of the vehicle. For example, method 600 (or steps thereof) may be continuously run on a loop to monitor upcoming elevation profiles and ensure that a battery of the vehicle is sufficiently charged to traverse the upcoming elevation. As another example, method 600 may performed dynamically (e.g., in response to a deviation in an expected/predicted vehicle trajectory, etc.).

At step 610, method 600 may include determining a vehicle trajectory. In various embodiments, the vehicle trajectory is determined based on a current direction of travel of the vehicle and/or a current road the vehicle is traveling on. For example, the vehicle trajectory may be determined by assuming that the vehicle will continue traveling along the road it is currently on in the direction it is currently traveling until the road ends. In some embodiments, the vehicle trajectory includes a route. A route may include a path from an origin (e.g., a current location of the vehicle) to a destination (e.g., a point a distance from the origin along improved surfaces, such as roads, that form a continuous path from the origin to the point). In some embodiments, the distance is a fixed distance (e.g., 100 miles, etc.). Additionally or alternatively, the distance may be determined dynamically (e.g., based on a current fuel level of a range extender, a current SoC of a vehicle battery, weather conditions, etc.). In some embodiments, the route includes one or more branches. For example, if the road the vehicle is traveling on ends in a 3-way intersection (e.g., having one “input” and two “outputs”), then step 610 may include generating two branches, each corresponding to an “output” of the 3-way intersection. Each branch may correspond to a different destination. In some embodiments, step 610 includes segmenting the vehicle trajectory. For example, if the vehicle trajectory includes 3 branches, then step 610 may include dividing the path associated with each of the 3 branches into a number of segments (e.g., of equal and/or different lengths, etc.).

At step 620, method 600 may include determining a difference between a maximum elevation along the vehicle trajectory and a minimum elevation along the vehicle trajectory. In some embodiments, step 620 includes determining the difference for one or more segments. In some embodiments, step 620 includes determining the maximum elevation for one or more segments where the maximum elevation corresponding to each of the one or more segments is located within the corresponding segment. In some embodiments, step 620 includes determining the minimum elevation for one or more segments. For example, the minimum elevation associated with each segment may be the minimum elevation located in each corresponding segment. As another example, the minimum elevation associated with each segment may be the minimum elevation located between a current location of the vehicle and the maximum elevation.

At step 630, method 600 may include determining an amount of energy required to traverse a route. For example, step 630 may include calculating a first amount of energy required to traverse a vertical distance from the minimum elevation to the maximum elevation, calculating a second amount of energy required to traverse a horizontal distance from the minimum elevation to the maximum elevation, and combining the first amount of energy and the second amount of energy. In some embodiments, the route is a path from a location of the minimum elevation to a location of the maximum elevation. In some embodiments, the route is a path from a current location of the vehicle to a location of the maximum elevation. In some embodiments, the route is the entire vehicle trajectory. In some embodiments, the route includes a number of branches. For example, the route may include three branches corresponding to branches of a current road the vehicle is traveling on (e.g., exits on a highway, etc.). In some embodiments, step 630 includes determining the amount of energy required to traverse a route segment. For example, step 630 may include determining an amount of energy required to traverse a route segment that includes the maximum elevation. In various embodiments, the amount of energy required to traverse the route is determined as described in relation to FIGS. 2-3. For example, step 630 may include multiplying a vertical distance by a variable that encodes various parameters such as vehicle mass, losses (e.g., road losses, aero losses, drivetrain inefficiencies, etc.), physical constants, and/or the like. In some embodiments, step 630 includes determining an amount of energy required to traverse a component of the route. For example, step 630 may include calculating an amount of energy required to traverse a vertical distance from the minimum elevation to the maximum elevation.

At step 640, method 600 may include determining an SoC buffer for a vehicle battery. For example, step 640 may include calculating an SoC for the vehicle battery that ensures that the vehicle will have enough energy to traverse an upcoming route segment. The SoC buffer may be determined based on at least one of (i) the amount of energy determined in step 630, (ii) a vehicle parameter, and/or (iii) a vehicle context. The vehicle parameter may include (i) a vehicle mass (e.g., either a fixed mass or a variable mass to account for different payloads, etc.), (ii) a vehicle energy buffer (e.g., depending on an operating mode of the vehicle such as a “hauling” mode, etc.), (iii) an energy and/or power output of the generator, (iv) a vehicle payload, and/or (v) a vehicle aerodynamic profile (e.g., determined by the aerodynamic area of the vehicle based on modifications such as adding a roof rack, etc.). The vehicle context may include (i) a temperature measurement, (ii) a wind speed measurement, (iii) a weather condition, and/or (iv) a surface type. In some embodiments, the vehicle context is determined based on sensor measurements of sensors positioned on the vehicle. For example, a vibration sensor may be used to determine the surface type and generate a friction coefficient corresponding to the surface type. Additionally or alternatively, the vehicle context may be determined based on receiving information from an external source (e.g., a database, etc.). For example, step 640 may include querying a weather database using location data to retrieve temperature measurements and wind speed/direction measurements associated with an area that include the route.

At step 650, method 600 may include comparing the SoC buffer to an SoC measurement. The SoC measurement may be a current SoC of the vehicle battery. For example, step 650 may include comparing a current SoC of the vehicle battery to a required SoC (e.g., the SoC buffer). In some embodiments, step 650 includes determining a time-until arrival. For example, step 650 may include calculating a time-until the vehicle arrives at a location (e.g., the minimum elevation, the beginning of a segment, etc.) based on a distance between the current location of the vehicle and the location (e.g., following improved surfaces rather than as the crow flies) and one or more speed limits associated with the corresponding improved surfaces. In some embodiments, step 650 includes comparing a time-until arrival to a time required to achieve the SoC buffer. For example, step 650 may calculate how long it will take to charge the vehicle battery from a current SoC to the SoC buffer using a range extender and will compare that value to a time-until arrival to determine when the range extender needs to begin actively increasing the SoC of the vehicle battery (e.g., rather than just maintaining a current SoC of the vehicle battery as may be the case in some embodiments). In various embodiments, the GCS may operate the generator based on step 650. If, based on step 650, the battery needs to be charged (e.g., a current SoC of the vehicle battery is less than the SoC buffer and/or the time-until arrival is less than or equal to an amount of time needed to achieve the SoC buffer, etc.), then method 600 may proceed with step 660. If, based on step 650, the battery does not need to be charged (e.g., a current SoC of the vehicle battery is significantly greater than the SoC buffer, etc.), then method 600 may proceed with step 670.

At step 660, method 600 may include charging the vehicle battery. For example, an ECU of the vehicle may operate a generator to charge the vehicle battery to the SoC buffer. Step 660 may include changing a power output of the generator (e.g., throttling the generator) such that the generator actively increases an SoC of the vehicle battery (e.g., inputs more power into the vehicle battery than the vehicle battery is outputting for operation of the vehicle, etc.). At step 670, method 600 may include not charging the vehicle battery. For example, an ECU of the vehicle may operate the generator to cause the generator to not charge the vehicle battery (e.g., by turning off the generator or causing the generator to remain off, etc.). Additionally or alternatively, step 670 may include charging the vehicle battery but only to maintain a current SoC of the vehicle battery (e.g., inputting power into the vehicle battery at approximately the same rate that the vehicle battery uses power to operate the vehicle, etc.). As used in relation to steps 660 and 670, “operating the generator” may refer to (i) causing the generator to charge the vehicle battery, (ii) changing an amount of energy that the generator supplies to the vehicle battery, and/or (iii) causing the generator to not charge the vehicle battery.

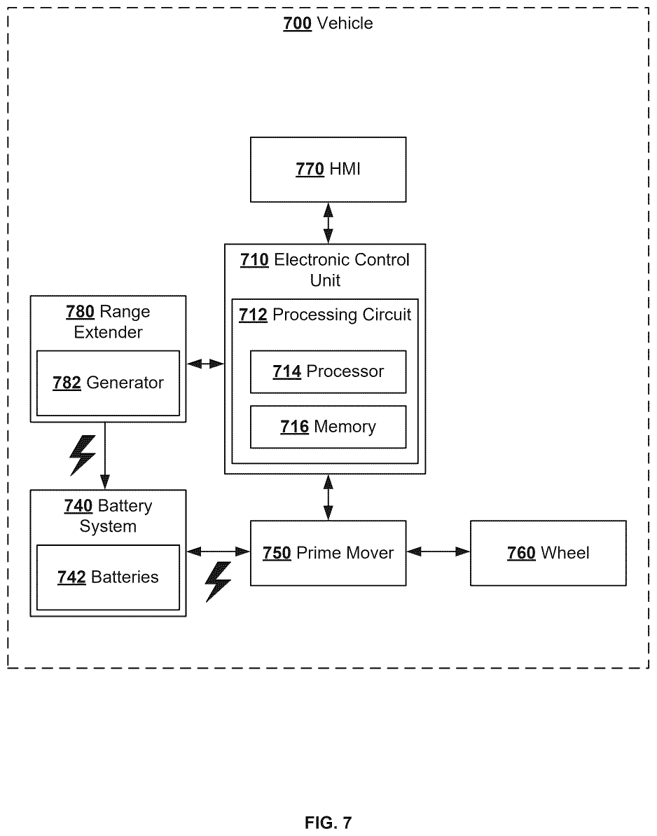

Referring to FIG. 7, example vehicle 700 is shown, according to an exemplary embodiment. In various embodiments, vehicle 700 is the same as or similar to vehicle 100. Vehicle 700 may include a chassis (not pictured) and a body (not pictured) coupled to the chassis. Vehicle 700 includes electronic control unit (ECU) 710, battery system 740, prime mover 750, a number of wheels 760, human-machine interface (HMI) 770, and range extender 780. In various embodiments, vehicle 700 includes a bus (e.g., a high-voltage bus, not pictured) that connects one or more components of vehicle 700. For example, vehicle 700 may include a high-voltage bus that selectively connects battery system 740, prime mover 750, a power converter (e.g., a DC to DC converter, etc.), an air-conditioning compressor, a heating unit, a suspension component, and/or the like.

ECU 710 may include processing circuit 712. Processing circuit 712 may include processor 714 and/or memory 716. Although this disclosure describes one example ECU including specified components in a particular arrangement, this disclosure contemplates any suitable computer system with any suitable number of any suitable components in any suitable arrangement. For example, ECU 710 may be an embedded computer system, a system-on-chip, a single-board computer system, a desktop computer system, a mesh computer system, or a combination of one or more of these. Where appropriate, ECU 710 may include one or more ECUs 710. For example, ECU 710 may be unitary or distributed, span multiple locations, machines, or data centers, or reside in the cloud. ECU 710 may be configured to receive inputs from HMI 770 and generate the control signals for prime mover 750 based on the user inputs.

Processing circuit 712 may include hardware for executing instructions, such as those making up a computer program. As an example and not by way of limitation, to execute instructions, processor 714 may retrieve/fetch instructions from an internal register, an internal cache, or memory 716. Memory 716 may include main memory for storing instructions for processor 714 to execute or data for processor 714 to operate on. In some embodiments, one or more memory management units (MMUs) are between processor 714 and memory 716. In some embodiments, memory 716 includes random access memory (RAM). Memory 716 may store data such as navigation data, vehicle parameters, and/or vehicle context data. For example, memory 716 may store a map including a number of improved surfaces (e.g., roads, etc.) as well as metadata (e.g., surface types, speed limits, etc.) associated with each improved surface. Memory 716 may include mass storage for data or instructions. For example, memory 716 may include a removable disk drive, flash memory, an optical disc, a magneto-optical disc, magnetic tape, or a Universal Serial Bus (USB) drive. Memory 716 may include removable or fixed media and may be internal or external to ECU 710. Memory 716 may include any suitable form of non-volatile, solid-state memory or read-only memory (ROM). Memory 716 may be and/or include a non-transitory computer-readable storage medium.

Battery system 740 may be and/or include a high-voltage battery assembly or traction battery. Battery system 740 may be supported within a battery housing (not pictured) and secured to the chassis. Battery system 740 may include one or more battery cells (shown as batteries 742) positioned within the battery housing. Batteries 742 may have various chemistries. In various embodiments, ECU 710 controls charging/discharging of battery system 740. Battery system 740 may provide power to prime mover 750. In some embodiments, battery system 740 receives power from prime mover 750 (e.g., via regenerative braking, etc.). Battery system 740 may receive power from range extender 780. In some embodiments, batteries 742 are removable (e.g., hot-swappable, etc.).

Prime mover 750 may be and/or include one or more electric motors. The electric motors may be used to transport/propel vehicle 700 and may be supplied with power by batteries 742 of battery system 740. Prime mover 750 may supply mechanical energy (e.g., rotational energy) via one or more linkages/components to wheel 760 for propelling vehicle 700. HMI 770 is configured to receive user inputs and/or transmit information/feedback to a user. For example, HMI 770 may receive a user selection of an operating mode. HMI 770 may include one or more displays and/or one or more input devices. For example, HMI 770 may include a touchscreen display. The display(s) may be or include a device or component for presenting GUIs. For example, the display(s) may include a liquid crystal display (LCD), a light-emitting diode (LED) display, and/or the like, capable of presenting GUIs. The input device(s) may receive user inputs. For example, the input device(s) may include a keypad, buttons, a microphone, a camera, and/or the like, which may be virtual (e.g., electronic digital representations), or physical input devices. In some embodiments, the display(s) and input device(s), or the functionality thereof, may be combined into a single device, such as a touchscreen display. In some embodiments, HMI 770 includes a touchscreen display in combination with one or more physical input devices, such as buttons, knobs, switches, etc.

Range extender 780 may provide power to battery system 740 for charging batteries 742. In various embodiments, range extender 780 includes generator 782. Generator 782 may include an internal combustion engine that drives an electrical generator. The electrical generator may generate AC power or DC power. Additionally or alternatively, generator 782 may include a compressed natural gas engine, a diesel engine, a fuel cell, a hydrogen engine, an electric motor, a photovoltaic cell, and/or the like. In various embodiments, generator 782 converts chemical energy into mechanical energy (e.g., via the combustion of a fuel, etc.) and/or mechanical energy into electrical energy (e.g., via a converter such as an AC/DC converter, a DC/AC converter, and/or the like). In some embodiments, range extender 780 is a range extender as described in U.S. patent application Ser. No. 18/925,528, filed on Oct. 24, 2024, which is hereby incorporated by reference in its entirety.

As utilized herein with respect to numerical ranges, the terms “approximately,” “about,” “substantially,” and similar terms generally mean±/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a vehicle, a Global Positioning System (GPS) receiver, etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user. Other kinds of devices may be used to provide for interaction with a user as well; for example, feedback provided to the user may be any form of sensory feedback (e.g., visual feedback, auditory feedback, or tactile feedback).

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

What is claimed is:

1. A series hybrid vehicle comprising:
a battery;
a generator; and
a computing device comprising:
a non-transitory computer-readable storage medium having instructions that, when executed by a processor, cause the computing device to:
determine a trajectory of the series hybrid vehicle;
determine, based on the trajectory, a difference between a maximum elevation along the trajectory and a minimum elevation along the trajectory;
determine, based on the difference, an amount of energy required to traverse a route segment comprising the maximum elevation;
determine, based on (i) the amount of energy, (ii) a vehicle parameter, and (iii) a vehicle context, a state of charge (SoC) buffer for the battery; and
operate the generator to charge the battery based on the SoC buffer.

2. The series hybrid vehicle of claim 1, wherein the vehicle parameter comprises at least one of (i) a vehicle mass, (ii) a vehicle energy buffer, (iii) an energy output of the generator, (iv) a vehicle payload, or (v) a temperature of the battery.

3. The series hybrid vehicle of claim 1, wherein the vehicle context comprises at least one of (i) a temperature measurement, (ii) a wind speed measurement, (iii) a weather condition, or (iv) a surface type.

4. The series hybrid vehicle of claim 3, wherein the instructions further cause the processor to determine the vehicle context corresponding to at least one of (i) a location of the route segment or (ii) a location of one or more route segments between the maximum elevation and a current location of the vehicle.

5. The series hybrid vehicle of claim 3, further comprising a sensor, and wherein the instructions further cause the processor to:
receive a measurement from the sensor; and
determine the vehicle context based on the measurement.

6. The series hybrid vehicle of claim 1, wherein operating the generator comprises comparing the SoC buffer to a current charge of the battery.

7. The series hybrid vehicle of claim 1, wherein the vehicle trajectory comprises a route having a length, and wherein the route comprises two branches, wherein each of the two branches corresponds to a different destination.

8. A method of charging a vehicle battery, the method comprising:
determining a vehicle trajectory of a vehicle;
determining, based on the vehicle trajectory, a difference between a maximum elevation along the vehicle trajectory and a minimum elevation along the vehicle trajectory;
determining, based on the difference, an amount of energy required to traverse a route segment comprising the maximum elevation;
determining, based on (i) the amount of energy, (ii) a vehicle parameter, and (iii) a vehicle context, a SoC buffer for a vehicle battery; and
operating a generator to charge the vehicle battery based on the SoC buffer.

9. The method of charging the vehicle battery of claim 8, wherein the vehicle parameter comprises at least one of (i) a vehicle mass, (ii) a vehicle energy buffer, (iii) an energy output of the generator, (iv) a vehicle payload, or (v) a temperature of the vehicle battery.

10. The method of charging the vehicle battery of claim 8, wherein the vehicle context comprises at least one of (i) a temperature measurement, (ii) a wind speed measurement, (iii) a weather condition, or (iv) a surface type.

11. The method of charging the vehicle battery of claim 10, wherein the method further comprises determining the vehicle context corresponding to at least one of (i) a location of the route segment or (ii) a location of one or more route segments between the maximum elevation and a current location of the vehicle.

12. The method of charging the vehicle battery of claim 10, wherein the method further comprises:
receiving a measurement from a sensor positioned on the vehicle; and
determining the vehicle context based on the measurement.

13. The method of charging the vehicle battery of claim 8, wherein the method further comprises comparing the SoC buffer to a current charge of the vehicle battery, and wherein the generator is operated in response to the comparison.

14. The method of charging the vehicle battery of claim 8, wherein the vehicle trajectory comprises a route having a length, and wherein the route comprises two branches, wherein each of the two branches corresponds to a different destination.

15. A non-transitory computer-readable medium comprising instructions that, when executed by one or more processors of one or more computing devices, cause the one or more processors to:
determine a vehicle trajectory of a vehicle;
determine, based on the vehicle trajectory, a difference between a maximum elevation along the vehicle trajectory and a minimum elevation along the vehicle trajectory;
determine, based on the difference, an amount of energy required to traverse a route segment comprising the maximum elevation;
determine, based on (i) the amount of energy, (ii) a vehicle parameter, and (iii) a vehicle context, a state of charge (SoC) buffer for a battery of the vehicle; and
operate a generator to charge the battery based on the SoC buffer.

16. The non-transitory computer-readable medium of claim 15, wherein the vehicle parameter comprises at least one of (i) a vehicle mass, (ii) a vehicle energy buffer, (iii) an energy output of the generator, (iv) a vehicle payload, or (v) a temperature of the battery.

17. The non-transitory computer-readable medium of claim 15, wherein the vehicle context comprises at least one of (i) a temperature measurement, (ii) a wind speed measurement, (iii) a weather condition, or (iv) a surface type.

18. The non-transitory computer-readable medium of claim 17, wherein the instructions further cause the one or more processors to determine the vehicle context corresponding to at least one of (i) a location of the route segment or (ii) a location of one or more route segments between the maximum elevation and a current location of the vehicle.

19. The non-transitory computer-readable medium of claim 17, wherein the instructions further cause the one or more processors to:
receive a measurement from a sensor positioned on the vehicle; and
determine the vehicle context based on the measurement.

20. The non-transitory computer-readable medium of claim 15, wherein operating the generator comprises comparing the SoC buffer to a current charge of the battery.
